(19) United States
(12) Patent Application Publication
(10) Pub. No.: US 2026/0339192 A1
(43) Pub. Date: Oct. 29, 2026

(54) STEREO ADAPTER, STEREO CAMERA, AND STEREO CAMERA SYSTEM

(71) Applicant: HITACHI, LTD., Chiyoda-ku, Tokyo (JP)

(72) Inventor: Kazuyoshi YAMAZAKI, Tokyo (JP)

(21) Appl. No.: 19/109,951

(22) PCT Filed: Sep. 19, 2023
(86) PCT No.: PCT/JP2023/033928

§ 371 Date: Mar. 7, 2025

(30) Foreign Application Priority Data
Oct. 4, 2022 (JP) 2022-160317

(51) Int. Cl. G03B 35/10

(52) U.S. Cl. CPC G03B 35/10

(57) ABSTRACT

In order to reduce the size of a stereo camera, the present invention is characterized in that: included are a prism and a prism for changing the angle of light rays transmitted from an object; light rays transmitted from the object are transmitted through prism and prism; and prism and prism are disposed so that there is a distance therebetween in the optical axis direction. Prism inwardly refracts the light rays, and prism outwardly refracts the light rays. The refractivity of prism is greater than the refractivity of prism.

### TECHNICAL FIELD

The present invention relates to a stereo adaptor, a stereo camera, and a stereo camera system.

### BACKGROUND ART

A stereo image processing apparatus (hereinafter, referred to as stereo camera) is known as an apparatus for three-dimensionally recognizing an object. The stereo camera uses differences in how the object is captured in images of multiple cameras arranged at different locations to detect disparity between the multiple images based on trigonometry. Then, the stereo camera detects the depth or position of the object by using this disparity. Using the stereo camera enables accurate detection of the position of the target object.

Meanwhile, since two camera modules equipped with lenses and sensors need to be used in the stereo camera, the stereo camera has problems in size reduction and cost. Patent Literatures 1, 2, and 3 are proposed for such problems.

An object of Patent Literature 1 is to provide a ranging apparatus that can be formed of fewer parts than a conventional ranging apparatus. For this object, Patent Literature 1 discloses a ranging apparatus including “a prism, a lens, and an imaging element. Light from an object enters the prism from two different directions. Moreover, the prism sends each of first light and second light entering the prism from the two different directions, to the lens. The lens focuses the first light and the second light sent from the prism on an imaging surface of the imaging element. The imaging surface includes a right region and a left region adjacent to each other as regions obtained by equally dividing the imaging surface. The first light sent from the lens is focused in the right region, and the second light sent from the lens is focused in the left region. The imaging element sends a right image obtained by focusing the first light and a left image obtained by focusing the second light to a controller. The controller measures a distance between the object and the ranging apparatus based on the right image and the left image sent from the imaging element” (see abstract).

Moreover, an object of Patent Literature 2 is to solve an image quality decrease and pseudo depth information due to a prism and perform three-dimensional imaging with a stereo adaptor that makes use of a natural advantage of a prism-type stereo adaptor and that is small in size, light in weight, and low in cost and has high image quality. For this object, Patent Literature 2 discloses an imaging apparatus and a three-dimensional image imaging method in which “imaging apparatus for imaging a multi-lens stereo image includes: a color imaging element 105 configured to obtain an object image signal by performing photoelectric conversion on an object image focused by an imaging optical system 101; a prism-type stereo adaptor 200 arranged in a stage preceding the imaging optical system 101 and configured to receive beams of light from the object at different positions depending on disparity and guide the beams of light to different regions of the imaging element 105; and a chromatic distortion correction circuit configured to correct chromatic distortion for the object image signal by providing a relative image position shift to each of multiple color components in the object image signal according to an image position shift of the color component that occurs due to the prism-type stereo adaptor” (see abstract).

Furthermore, Patent Literature 3 relates to an optical part for three-dimensional video imaging and a three-dimensional video imaging apparatus using this optical part that enable three-dimensional imaging with one camera. Particularly, an object of Patent Literature 3 relates to an optical part for three-dimensional video imaging formed of an arrowhead-shaped combined achromatic prism that is fixed at a vertex and an apparatus such as a still camera or an endoscope that includes this optical part and that three-dimensionally captures a 3D video. For this object, Patent Literature 3 discloses “an optical lens for three-dimensional video imaging provided with an arrowhead-shaped combined achromatic prism on a front end with a vertex of the prism directed toward the object side, wherein a ridge line of the fixed vertex of the combined achromatic prism is an arc of r1 calculated based on a vertical viewing angle, the combined achromatic prism has an arc that has a radius of r2 and that is concentric to the arc of r1 also on the valley side, and a slit diaphragm is provided near an aperture diaphragm”, an optical part for three-dimensional video imaging using this optical lens, and a three-dimensional video imaging apparatus using this optical part (see abstract).

### CITATION LIST

### Patent Literature

Patent Literature 1: JP2020-91154A.

Patent Literature 2: JP2003-47028A.

Patent Literature 3: JP 2000-193883A.

### SUMMARY OF INVENTION

### Technical Problem

The technique described in Patent Literature 1 implements a stereo camera with one lens and one imaging element by using a prism to achieve size reduction and cost reduction. Meanwhile, when the prism is used, colors of light transmitted through the prism are separated, and this affects disparity.

Meanwhile, in the techniques described in Patent Literatures 2 and 3, two prisms are used to suppress color distortion. Moreover, Patent Literatures 1, 2, and 3 state that the size of the stereo camera can be reduced. However, achieving a small stereo camera with these techniques has the following major problem. Specifically, the stereo camera detects images of two viewpoints, and the larger the distance between these two viewpoints (hereinafter, referred to as base line length) is, the higher the accuracy of the detection is. Moreover, increasing the base line length enables detection of a far-away point. However, the techniques described in Patent Literatures 1, 2, and 3 have such a problem that the distance between the prism and the lens needs to be increased to increase the base line length, and the size of the stereo camera is increased with this increase of the distance. This problem is not described in Patent Literatures 1, 2, and 3, and contents relating to a method of solving this problem is also not described therein as a matter of course.

The present invention has been made in view of the background as described above, and an object of the present invention is to improve ranging accuracy of a stereo camera.

### Solution to Problem

In order to solve the problems described above, the present invention includes a first light ray angle conversion element and a second light ray angle conversion element configured to change angles of light rays propagating from a target object, the light rays propagating from the target object propagate through insides of the first light ray angle conversion element and the second light ray angle conversion element, and the first light ray angle conversion element and the second light ray angle conversion element are arranged at a predetermined distance from each other with respect to an optical axis.

Other solving means are described as appropriate in the embodiments.

### Advantageous Effects of Invention

The present invention can improve ranging accuracy of a stereo camera.

### BRIEF DESCRIPTION OF DRAWINGS

FIG. 1 is a configuration diagram of an optical system of a stereo camera according to a first embodiment.

FIG. 2 is a configuration diagram of an optical system of a stereo camera in a comparative example.

FIG. 3 is a diagram showing a picture of an image on a sensor surface in the case where a person is detected by the stereo camera in the comparative example.

FIG. 4A is a graph showing a relationship between a camera module incidence angle and a stereo camera incidence angle in the present embodiment.

FIG. 4B is a graph showing the relationship between the camera module incidence angle and the stereo camera incidence angle in the comparative example.

FIG. 5A is a graph showing light dispersion in the configuration described in the first embodiment.

FIG. 5B is a graph showing the light dispersion obtained in the configuration of the comparative example.

FIG. 6 is a graph showing relationships between a module distance and a base line length.

FIG. 7 is a graph showing the base line length with respect to the stereo camera incidence angle.

FIG. 8A is a diagram showing a configuration of a stereo camera system.

FIG. 8B is a diagram showing a detailed configuration of a stereo disparity image generator.

FIG. 9 is a diagram showing a hardware configuration of an image processing apparatus.

FIG. 10 is a diagram showing a modified example of the stereo camera according to the first embodiment.

FIG. 11A is a diagram (part 1) showing an arrangement example of a sensor.

FIG. 11B is a diagram (part 2) showing an arrangement example of the sensor.

FIG. 11C is a diagram (part 3) showing an arrangement example of the sensor.

FIG. 12 is an optical path diagram in the case where a refractive index of a prism in the comparative example is increased.

FIG. 13 is a diagram showing an example of an image focused on the sensor in the configuration in which the refractive index of the prism in the comparative example is increased.

FIG. 14 is an optical path diagram of the stereo camera according to the present embodiment.

FIG. 15 is a diagram showing an example of an image focused on the sensor by the configuration of the present embodiment.

FIG. 16 is a configuration diagram of an optical system of a stereo camera according to a second embodiment.

FIG. 17 is a diagram showing a modified example of the stereo camera according to the second embodiment.

FIG. 18 is a configuration diagram of an optical system of a stereo camera according to a third embodiment.

FIG. 19 is a diagram showing another example of the stereo camera according to the third embodiment.

### DESCRIPTION OF EMBODIMENTS

The present embodiments are explained below with reference to the attached drawings. In the attached drawings, elements that are functionally the same are denoted by the same numbers in some cases. Note that, although the attached drawings show the embodiments following principles of the present disclosure, these embodiments are for understanding of the present disclosure, and are not used at all to interpret the present disclosure in a limited manner. Statements in the present description are merely typical examples, and do not limit the scope of claims or the application examples of the present disclosure in any sense.

Although the present embodiments are explained in such detail that those skilled in the art can carry out the present disclosure, other modes are also possible. Moreover, it is necessary to understand that changes of configurations and structures and replacement of various elements are possible without departing from the spirit and scope of the technical ideas of the present disclosure. Accordingly, the following description should not be interpreted in a limited manner.

### First Embodiment

FIG. 1 is a configuration diagram of an optical system of a stereo camera 1 according to a first embodiment.

The stereo camera 1 includes a camera module 10 formed of a lens 11 and a sensor 12 and a stereo adaptor 13 formed of a prism P10 and a prism P20. Note that, in the present embodiment, the sensor 12 indicates an imaging element. Note that a plane T is described later. Moreover, α10, α20, β10, and β20 are also described later.

### Comparative Example

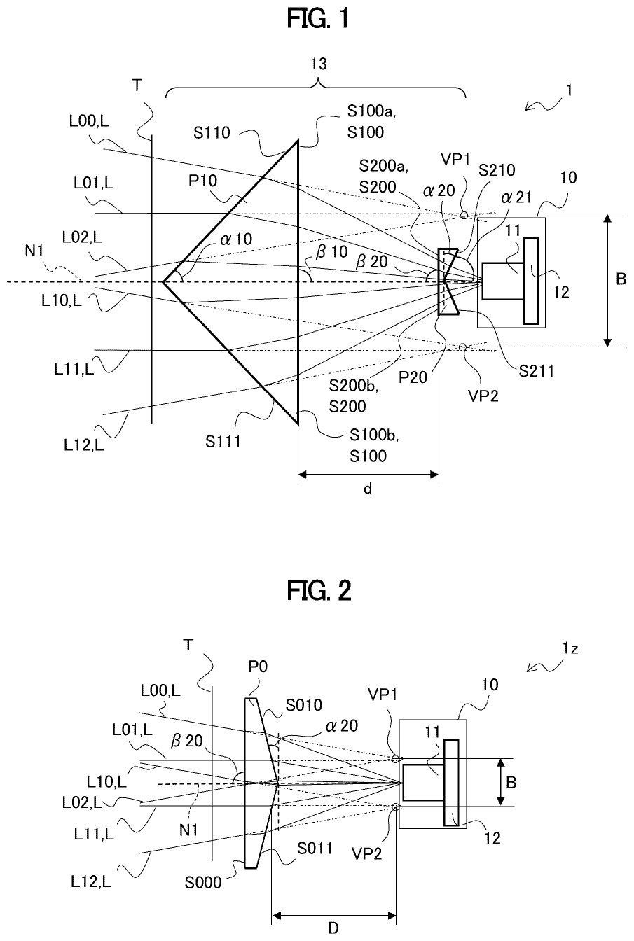

First, a problem of a comparative example is explained with refence to FIG. 2.

FIG. 2 is a configuration diagram of an optical system of a stereo camera 1z described in a Patent Literature 1 as a comparative example.

This configuration is characterized in that one prism P0 is used in addition to the lens 11 that is a light condenser configured to focus an image formed of light transmitted through the prism P10 and the prism P20 and the sensor 12 that is a light receiver configured to detect the focused image. Note that, although the orientation of the prism P0 in FIG. 2 is opposite to that in the drawings shown in Patent Literature 1, the results are the same. Light rays L00 to L02 and light rays L10 to L12 propagating from an imaging target object (hereinafter, referred to as target object: not shown) are refracted on a surface S000, a surface S010, and a surface S011 of the prism P0. Then, the light rays L00 to L02 and the light rays L10 to L12 enter the camera module 10 formed of the lens 11 and the sensor 12. Note that, in the present embodiment, the light rays L00 to L02 and L10 to L12 are collectively referred to as light rays L as appropriate. In this case, the light rays L traveling from the same direction such as, for example, the light ray L00 and the light ray L10 are two beams of light that are each refracted on the surface S000 and then on the surface S010 or refracted on the surface S000 and then on the surface S011. Then, the two beams of light enter the camera module 10 at different incidence angles, respectively. Note that reference numeral N1 denotes an optical axis of the lens 11.

In FIG. 2, lines extended from the light rays L traveling toward the prism P0 among the light rays L entering the camera module 10 are shown by dot-dash lines. Specifically, the lines extended from the light rays L entering the prism P0 as they are shown by the dot-dash lines. Moreover, points where the dot-dash lines substantially intersect one another are assumed to be defined as a virtual viewpoint VP1 and a virtual viewpoint VP2. The virtual viewpoint VP1 and the virtual viewpoint VP2 indicate effective positions of the camera module 10. Specifically, the virtual viewpoint VP1 and the virtual viewpoint VP2 are locations where two camera modules 10 are to be installed in a stereo camera not using the prism P0. In the configuration shown in FIG. 2, the light rays L are each refracted on the surface S000 and the surface S010 or on the surface S000 and the surface S011 of the prism P0. The refracted light rays L enter the camera module 10. Accordingly, in the camera module 10, detection is the same as the case where the light rays L are detected at each of the virtual viewpoint VP1 and the virtual viewpoint VP2. Specifically, images detected at the virtual viewpoint VP1 and the virtual viewpoint VP2 are detected in the sensor 12 of the camera module 10. In a precise sense, the virtual viewpoint VP1 and the virtual viewpoint VP2 correspond to positions of pupils of lenses 11 of the camera modules 10 in the stereo camera 1 not using the prism P0. In the stereo camera 1z of the present configuration (configuration shown in FIG. 2), an interval between the virtual viewpoint VP1 and the virtual viewpoint VP2 is a base line length B. Note that the plane T is described later. Note that α20 and β20 in FIG. 2 are described later.

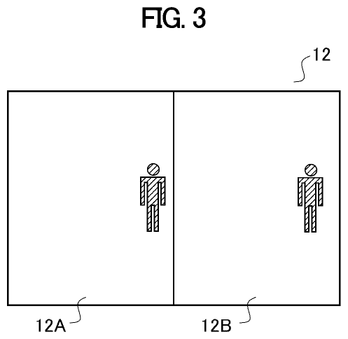

FIG. 3 is a diagram showing a picture of an image on a sensor surface in the case where a person is detected by the stereo camera 1z shown in FIG. 2.

In this case, the light rays L from the person corresponding to the light rays L00 and L10 in FIG. 2 are assumed to be detected. In this case, an image of the person is focused in each of two sensor regions 12A and 12B as viewed from the virtual viewpoint VP1 and the virtual viewpoint VP2 on the sensor surface. Note that the sensor region 12A and the sensor region 12B indicate regions obtained by dividing one sensor 12 into two, respectively. The sensor region 12A is a first light receiving region, and the sensor region 12B is a second light receiving region. Image detection is achieved by focusing an image on the sensor surface. Next, a calibration process such as distortion correction and brightness correction is performed on the image detected by the sensor 12. Then, this image is divided into two images detected in the sensor region 12A and the sensor region 12B, and disparity of the two images is detected to measure the distance to the target object. Next, two problems of the comparative example are explained.

The first problem is an effect of light dispersion. Since a glass material used for the prism P0 has a refractive index that varies depending on wavelength (color), the entering light rays L are outputted at angles that vary depending on color. Moreover, beams of light entering the lens 11 at different angles fall on different positions on the surface of the sensor 12 depending on color. In this case, since a refraction direction of the light rays L on the surface S000 and the surface S010 of the prism P0 and that on the surface S000 and the surface S011 are substantially opposite to each other, directions in which colors are separated in the two images are different. For example, in the case of blue, since the refraction by the prism P0 is larger than those of the other colors, blue color components in the two images fall on the center side of the sensor 12. This leads to detection of smaller disparity. Meanwhile, in the case of red, since the refraction by the prism P0 is smaller than those of the other colors, red color components in the two images fall on the relatively-outer sides of the sensor 12. This leads to detection of larger disparity. Such a phenomenon is referred to as light dispersion in the present embodiment. In other words, a ranging result that varies depending on color is outputted even for a distance to the same target object. This is the first problem. Since changing the ranging result depending on the color of the target object is a very complicated process, there is a demand for handling this problem in a simple configuration. To counter this, Patent Literatures 2 and 3 suppress the effect of the light dispersion by using two prisms that are in contact with each other and that have different refractive indices.

The second problem is an increase in accuracy of ranging. In the stereo camera 1z, the ranging accuracy is determined depending on a focal distance, the base line length B, and a sensor pixel pitch. The higher the ranging accuracy is, the greater the distance of performable detection is. Accordingly, the ranging accuracy also affects an increase in ranging distance. In order to achieve the increase in accuracy of ranging in the techniques described in Patent Literatures 1, 2, and 3, there is a problem of the base line length B. In order to increase the base line length B in the techniques described in Patent Literatures 1, 2, and 3, the size of the stereo camera 1z needs to be increased. In the case of FIG. 2, in order to increase the base line length B that is the interval between the virtual viewpoint VP1 and the virtual viewpoint VP2, an interval D between the camera module 10 and the prism P0 needs to be increased. However, this has such a problem that the size of the stereo camera 1z is increased with the increase of the interval D. This problem is not described in Patent Literatures 1, 2, and 3, and contents relating to a method of solving this problem are also not described as a matter of course.

Meanwhile, the stereo camera 1 of the first embodiment shown in FIG. 1 can solve the problems of the effect of light dispersion and the base line length. This is explained below in detail with reference to FIG. 1. Note that, since the configuration of the camera module 10 is the same as that in FIG. 2, components thereof are denoted by the same reference numerals, and explanation thereof is omitted.

As shown in FIG. 1, the stereo camera 1 is characterized in that the stereo camera 1 is formed of the prism P10 and the prism P20, and an interval between the two prisms P10 and P20 is such that the prisms P10 and P20 are separated from each other in the front-rear direction by a distance d that is a predetermined distance. Note that, in the present embodiment, the entrance side of the light rays L is a preceding stage, and the sensor 12 side is a subsequent stage. Specifically, the prism P10 and the prism P20 are arranged in series at the distance d with respect to the optical axis N1. Note that the prism P10 is a first light ray angle conversion element that changes the angles of the light rays L propagating from the target object, and is a first prism. Moreover, the prism P20 is a second light ray angle conversion element that changes the angles of the light rays L propagating from the target object, and is a second prism that is a prism different from the prism P10. In the present embodiment, the angle of each light ray L is an angle formed between the optical axis N1 and a traveling direction of the light ray L. Moreover, simple description of “angle” in the present embodiment means the angle formed between the optical axis N1 and traveling direction of the light ray L.

The prism P10 includes a surface S110, a surface S111, and a surface S100. The surface S100 can be divided into a surface S100a that faces the surface S110 and a surface S100b that faces the surface S111. The surface S110 and the surface S100a form a first region, and the surface S111 and the surface S100b form a second region.

The prism P20 includes a surface S210, a surface S211, and a surface S200. The surface S200 can be divided into a surface S200a that faces the surface S210 and a surface S200b that faces the surface S211. The surface S210 and the surface S200a form a third region, and the surface S211 and the surface S200b form a fourth region.

The light rays L00 to L02 propagating from the target object are refracted on the surface S110 of the prism P10, then on the surface S100a, then on the surface S200a of the prism P20, and then on the surface S210. Similarly, the light rays L10 to L12 are refracted on the surface S111 of the prism P10, then on the surface S100b, then on the surface S200b of the prism P20, and then on the surface S211. Then, the light rays L00 to L02 and the light rays L10 to L12 enter the camera module 10 formed of the lens 11 and the sensor 12. As described above, the light rays L propagating from the target object propagate through the insides of the prism P10 and the prism P20.

In this case, the light rays L emitted from the same direction such as, for example, the light ray L00 and the light ray L10 are each refracted on the surface S110, then on the surface S100a, then on the surface S200a, and then on the surface S210, or on the surface S111, then on the surface S100b, then on the surface S200b, and then on the surface S211. Then, the light rays L from the same direction such as the light ray L00 and the light ray L10 enter the camera module 10 at different incidence angles.

Lines extended from the light rays L traveling toward the prism P10 among the light rays L entering the camera module 10 are shown by dot-dash lines as in FIG. 2. Moreover, points where the dot-dash lines intersect one another are defined as the virtual viewpoint VP1 and the virtual viewpoint VP2. The virtual viewpoint VP1 and the virtual viewpoint VP2 indicate the effective positions of the camera module 10. As described above, the virtual viewpoint VP1 and the virtual viewpoint VP2 are locations where two camera modules are to be arranged in a stereo camera not using the prisms. Since the light rays L are refracted on multiple surfaces and then enter the camera module 10, images detected at the sensor 12 are images detected at the virtual viewpoint VP1 and the virtual viewpoint VP2, respectively.

As described above, a characteristic of the stereo camera 1 described in the first embodiment is such that the two prisms P10 and P20 are arranged in series with respect to the optical axis N1. Moreover, the interval between the two prisms P10 and P20 is such that the prisms P10 and P20 are separated from each other in the front-rear direction by the distance d. Such a configuration allows the number of camera modules 10 to be one, and can reduce the number of parts in the stereo camera 1 from that in the stereo camera not using a prism. Accordingly, it is possible to reduce the size and cost of the stereo camera 1.

Moreover, the two prisms P10 and P20 vary in the refraction index and the refraction angle. The two prisms P10 and P20 have two major effects. The first effect is light dispersion compensation. This is the same effects as those in Patent Literatures 2 and 3. Optimizing the refraction indices and the refraction angles of the two prisms P10 and P20 can reduce the effect of light dispersion. Note that the refraction angle is an angle formed between each light ray L entering the prism P10 or P20 and the outputted light ray L, and is an angle of the light ray L changed in the prism P10 or P20.

The second effect is an increase in accuracy of ranging. In the stereo camera 1 shown in the first embodiment, the prism P10 is used to greatly refract the light rays L from the measurement target object. In other words, the refractive index of the prism P10 is larger than that of the prism P0 shown in FIG. 2. Moreover, in the prism P10, the beams of light entering the prism P10 are refracted in such directions that the beam of light refracted on the surface S110 and the surface S100a and the beam of light refracted on the surface S111 and the surface S100b intersect each other. Similarly, in the prism P20, the beams of light entering the prism P20 are refracted in such directions that the beam of light refracted on the surface S210 and the surface S200a and the beam of light refracted on the surface S211 and the surface S200b intersect each other. As a result, the images as shown in FIG. 3 are displayed on the sensor 12 also in the configuration shown in FIG. 1.

Specifically, as shown in FIG. 1, the direction in which the angle of the entering light rays L is changed on the surface S110 and the surface S100a of the prism P10 and that on the surface S111 and the surface S100b are substantially opposite to each other. Moreover, the direction in which the angle of the entering light rays L is changed on the surface S210 and the surface S200a of the prism P20 and that on the surface S211 and the surface S200b are substantially opposite to each other.

Moreover, the prism P20 refract each light ray L in the opposite direction to the refraction direction in the prism P10. In other words, the prism P10 and the prism P20 refract light in opposite directions. Specifically, the direction of the angle change of the light rays L entering the surface S110 and the surface S100a of the prism P10 is opposite to the direction of the angle change of the light rays L entering the surface S200a and the surface S210 of the prism P20. Similarly, the direction of the angle change of the light rays L entering the surface S111 and the surface S100b of the prism P10 is opposite to the direction of the angle change of the light rays L entering the surface S200b and the surface S211 of the prism P20. Note that cross sections of the prisms P10 and P20 are shown in FIG. 1, and are line symmetric in regard to the optical axis N1 (prisms P10 and P20 actually have line symmetric shapes with respect to the optical axis N1). The same applies to the drawings of FIG. 2 and beyond.

Moreover, in the prism P10, the angles of the entering light rays L are changed in directions toward the optical axis N1. In the prism P20, the angles of the entering light rays L are changed such that the light rays L travel in the opposite direction to that in the prism P10.

Moreover, the lens 11 causes the light rays L transmitted through the surfaces S110 and S100a of the prism P10 and the surfaces S200a and S210 of the prism P20 to fall on the sensor region 12A (see FIG. 3) of the sensor 12. Similarly, the lens 11 causes the light rays L transmitted through the surfaces S100b and S111 of the prism P10 and the surfaces S200b and S211 to fall on the sensor region 12B (see FIG. 3) of the sensor 12.

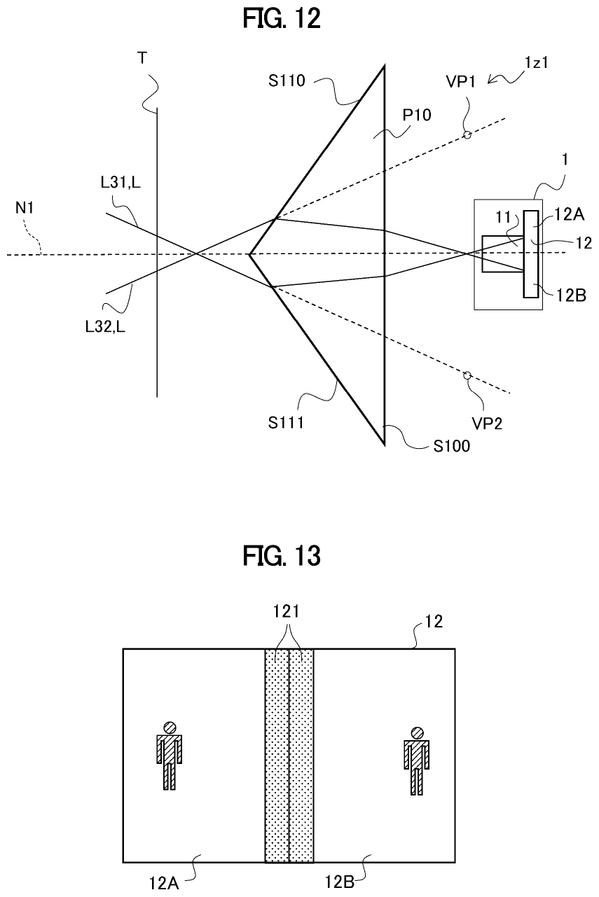

Configuring the stereo camera 1 as described above can increase the base line length B that is the interval between the virtual viewpoint VP1 and the virtual viewpoint VP2 without increasing the distance d between the two prisms P10 and P20. Specifically, as apparent from comparison of FIGS. 1 and 2, in the stereo camera 1, the refractive index of the prism P10 is increased. This can increase the distance between the virtual viewpoint VP1 and the virtual viewpoint VP2 (that is, the base line length B) from that in the comparative example. Note that, when the refractive index of the prism P0 is simply increased in the configuration of FIG. 2, an image usable for the ranging in the image obtained in the sensor 12 becomes smaller. This problem is described later with reference to FIGS. 12 to 15.

Note that the two prisms P10 and P20 used in the first embodiment are such that the refractive index and prism angle of the prism P10 are both larger than those of the prism P20. Configuring the stereo camera 1 as described above allows the stereo camera 1 to obtain the above-mentioned effects. Note that advantages of providing the prism P20 are described later. Moreover, the prism P20 may be brought closer to the camera module 10. For example, the prism P20 may be combined with the lens 11. This can achieve size reduction and material cost reduction of the prism.

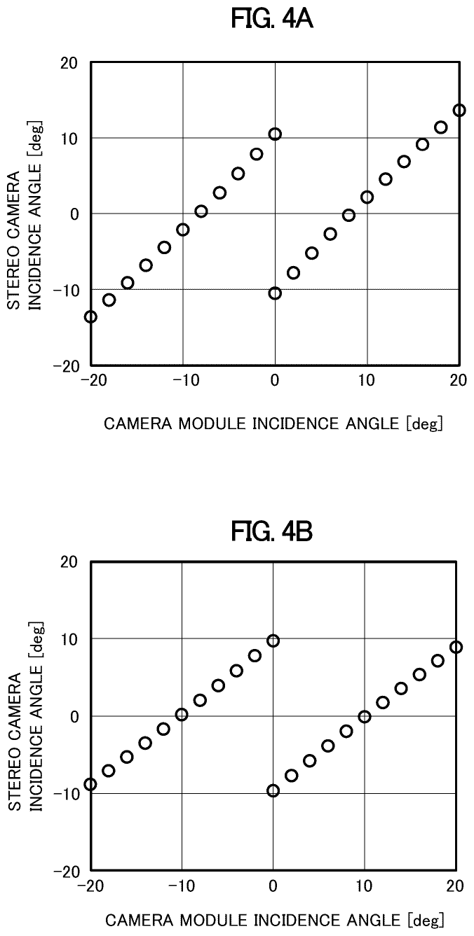

FIGS. 4A and 4B are graphs showing relationships between a camera module incidence angle and a stereo camera incidence angle in the configurations shown in FIGS. 1 and 2.

FIG. 4A shows the camera module incidence angle and the stereo camera incidence angle in the present embodiment. Meanwhile, FIG. 4B shows the camera module incidence angle and the stereo camera incidence angle in the configuration of the comparative example shown in FIG. 2. In each of FIGS. 4A and 4B, the horizontal axis represents the camera module incidence angle that is the incidence angle of the light ray L to the camera module 10, and the vertical axis represents the stereo camera incidence angle that is the incidence angle to the stereo camera 1 or 1z. The stereo camera incidence angle is an angle of each of the light rays L entering the surface S110 and S111 of the prism P10. Moreover, the stereo camera incidence angle indicates the incidence angle of the light ray L to the plane T (see FIGS. 1 and 2) perpendicular to the optical axis N1. Note that, in this example, a limiting condition is such that the camera module 10 with a camera module incidence angle width of about 40 degrees is used, and the stereo cameras 1 and 1z with an incidence angle width of ±20 degrees, respectively, for the left and right sides are configured.

Conditions of the prisms P0, P10, and P20 and the camera module 10 in the case where the results shown in FIGS. 4A and 4B are measured are described below. Note that the prism angles α10, β10, α20, and β20 described below are shown in FIG. 1, and the prism angles α0 and β0 are shown in FIG. 2.
Prisms P10, P20, and P0
(FIG. 4A) FIG. 1 configuration (first embodiment)
Prism P10 Prism angle α10=44 degrees, prism angle β10=90 degrees, glass material: BK7
Prism P20 Prism angle α20=25.3 degrees, prism angle β20=90 degrees, glass material: BaF10
(FIG. 4B) FIG. 2 configuration (Patent Literature 1)
Prism P0 Prism angle α0=18 degrees, prism angle β0=90 degrees, glass material: BK7
Camera module 10 (common to FIGS. 4A and 4B)
Lens 11 Focal length 6.0 mm, perspective projection
Sensor 12 Pixel pitch 2.25 μm

Note that the prism angle α10 is an angle of a tilted portion (surfaces S110 and S111) with the smallest tilt with respect to the optical axis N1 among the tilted portions (surfaces S110, S111, and S100) forming the prism P10. Moreover, a prism angle α21 of FIG. 1 is 90 degrees-α20. Moreover, the prism angle α21 is a prism angle of a tilted portion (surfaces S210 and S211) with the smallest tilt with respect to the optical axis N1 among the tilted portions (surfaces S210, S211, and S200) forming the prism P20. As described above, the prism angle α10 is smaller than the prism angle α21. The refractive index of the prism P10 is thus larger than the refractive index of the prism P20 as described above. Making the refractive index of the prism P10 larger than the refractive index of the prism P20 causes the light ray L refracted toward the optical axis N1 side in the prism P10 to enter the camera module 10 without scattering in the prism P20.

Note that the camera module incidence angle of 0 degrees corresponds to the center of the sensor 12. Moreover, the camera module incidence angle from −20 degrees to 0 degrees corresponds to the sensor region 12A shown in FIG. 3. Furthermore, the camera module incidence angle from 0 degrees to +20 degrees corresponds to the sensor region 12B shown in FIG. 3.

In FIG. 4B, it is found that the stereo camera incidence angle is −10 degrees to +10 degrees in the case where the camera module incidence angle is −20 degrees to 0 degrees and 0 degrees to +20 degrees. Accordingly, it is found that detection of disparity is possible by performing a stereo process on an image of the camera module incidence angle of −20 degrees to 0 degrees and an image of the camera module incidence angle of 0 degrees to +20 degrees. Moreover, in FIG. 4A, it is found that the stereo camera incidence angle is about −10 degrees to +10 degrees in the case where the camera module incidence angle is −17 degrees to 0 degrees and 0 degrees to +17 degrees. Accordingly, it is found that detection of disparity is possible by performing the stereo process on an image of the camera module incidence angle of −17 degrees to 0 degrees and an image of the camera module incidence angle of 0 degrees to +17 degrees.

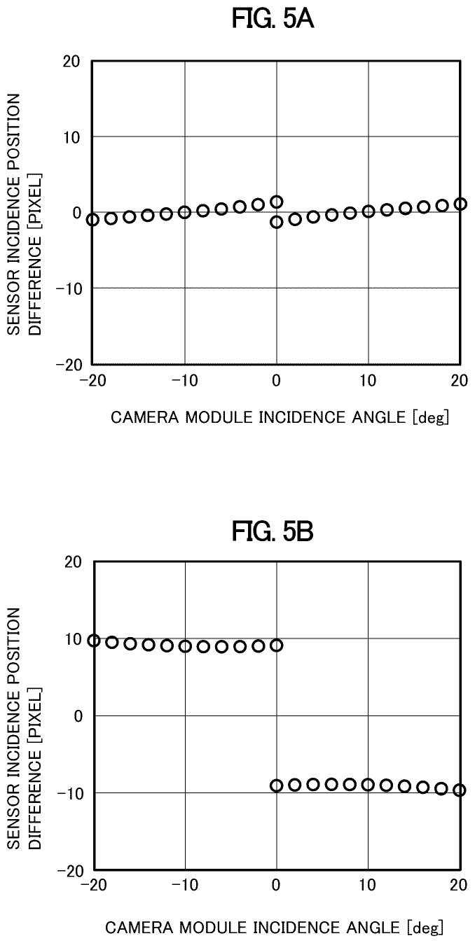

Next, effects on the light dispersion are explained with reference to FIGS. 5A and 5B.

FIG. 5A is a graph showing the light dispersion in the configuration described in the first embodiment. Moreover, FIG. 5B is a graph showing the light dispersion obtained in the configuration of the comparative example shown in FIG. 2. In each of these graphs, the horizontal axis represents the camera module incidence angle, and the vertical axis represents a sensor incidence position difference between blue (435.8 nm) and red (656.3 nm). The sensor incidence position difference between blue and red is a difference between an incidence position on the sensor 12 (sensor incidence position) for blue and an incidence position on the sensor 12 for red. The larger the value of this difference is, the larger the degree of light dispersion is. Note that the configurations of the prisms P0, P10, and P20 and the camera module 10 in the case where the results of FIGS. 5A and 5B are obtained are the same as those for FIGS. 4A and 4B.

In FIG. 5B that is the result of the comparative example, it is found that the sensor incidence position difference in the case where the camera module incidence angle is −20 degrees to 0 degrees is inverted from that in the case where the camera module incidence angle is 0 degrees to +20 degrees. This is because the refraction direction of the light rays L entering the surface S000 of the prism P0 and then the surface S010 is substantially opposite to the refraction direction of the light rays L entering the surface S000 and then the surface S011 as described above, and thus the direction in which the colors separate varies between the two images. Accordingly, in the configuration of the comparative example, a ranging result that varies depending on color is outputted even for the same target object. In the result shown in FIG. 5B, the sensor incidence position difference at the camera module incidence angle of −20 degrees to 0 degree and 0 degrees to +20 degrees is ±10 pixels. Specifically, there is a difference of 20 pixels for the case where the camera module incidence angle is −20 degrees to 0 degrees and the case where the camera module incidence angle is 0 degrees to +20 degrees. For example, a disparity difference of 20 pixels in a left-right direction thereby occurs between the case where a blue target object is detected and the case where a red target object is detected. A normal stereo camera detects disparity at an accuracy of one pixel or less. Accordingly, a disparity difference of 20 pixels generates a large ranging error. Note that the normal stereo camera is a stereo camera not using a prism.

Meanwhile, it is found that, in the configuration described in the present embodiment shown in FIG. 5A, the sensor incidence position difference is smaller than that in the configuration of the comparative example shown in FIG. 5B. Moreover, the fine sensor incidence position difference occurring in each of the left and right plot groups on the sheet surface are substantially symmetric about points where the camera module incidence angle is ±10 degrees (separation directions match). Note that, as described above, the camera module incidence angle of −17 degrees to 0 degrees corresponds to the sensor region 12A, and the camera module incidence angle of −0 degrees to +17 degrees corresponds to the sensor region 12B. In other words, the horizontal axes of FIGS. 5A and 5B correspond to the direction in which the sensor region 12A and the sensor region 12B are arranged side by side. Specifically, the separation direction in the entrance of red and blue in the sensor region 12A matches that in the sensor region 12B, in the same direction as the direction in which the sensor region 12A and the sensor region 12B are arranged side by side. Note that the plot group on the left side of the sheet surface of FIG. 5A shows the sensor incidence position difference in the image of the sensor region 12A. Moreover, the plot group on the right side of the sheet surface shows the sensor incidence position difference in the sensor region 12B.

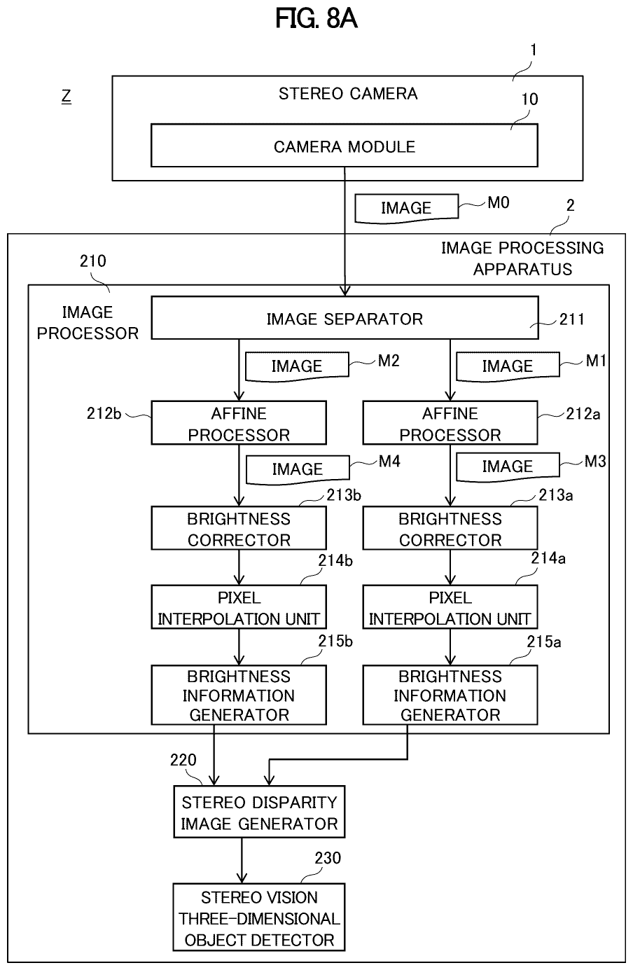

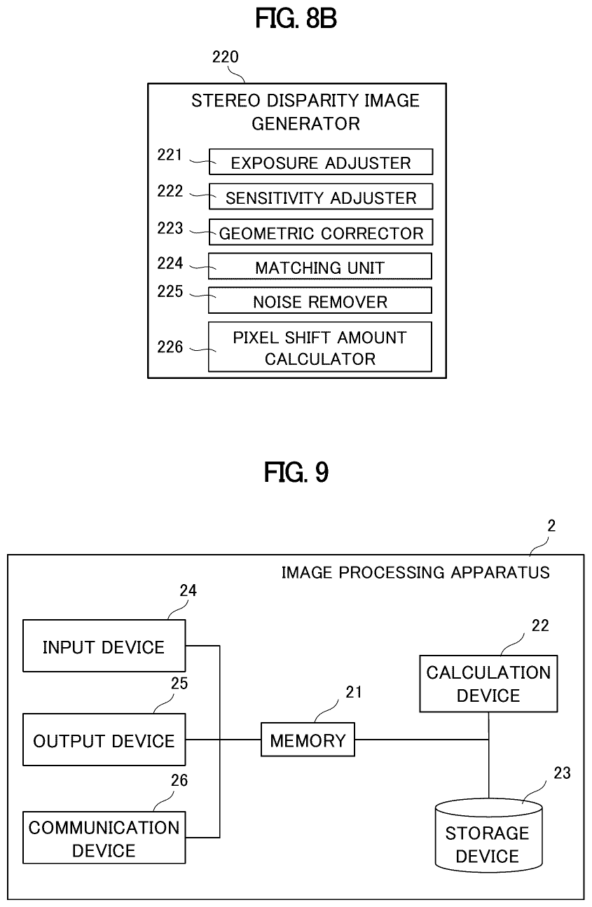

A case where a target object in a stereo camera incidence angle +10 degrees direction is detected is considered with reference to FIG. 4A. In this case, an image processor 210 (see FIG. 8) only needs to refer to 0 degrees and +17 degrees for the camera module incidence angle in the horizontal axis of FIG. 4A. Specifically, in FIG. 4A, the stereo camera incidence angle of +10 degrees correspond to the camera module incidence angles of 0 degrees and +17 degrees. Accordingly, the light ray L coming from the stereo camera incidence angle +10 degrees direction is an image corresponding to the camera module incidence angles of 0 degrees and +17 degrees. Based on this, with reference to FIG. 5A, a value of the plot where the camera module incidence angle is 0 degrees (upper plot among two plots) is substantially the same as a value of the plot where the camera module incidence angle is +17 degrees. Specifically, in the image of the sensor region 12A and the image of the sensor region 12B, color dispersions occurring in images formed by the light rays entering the stereo camera 1 at the same stereo incidence angle are substantially the same. Accordingly, when disparity calculation is performed, it is possible perform a cancel process depending on the sensor incidence position difference corresponding to each camera module incidence angle. Specifically, as shown in FIG. 5A, since the sensor incidence position differences in the two images on the sensor 12 occur in the same direction, the color dispersion can be cancelled by the disparity calculation. The tendency of the sensor incidence position difference is the same also in the range in which the stereo camera incidence angle shown in FIG. 4A is −10 degrees to +10 degrees. The range in which the stereo camera incidence angle shown in FIG. 4A is −10 degrees to +10 corresponds to the range in which the camera module incidence angle in the horizontal axis of FIG. 5A is −17 degrees to 0 degrees and 0 degrees to +17 degrees. Accordingly, the color dispersion can be cancelled by a similar process also at these stereo incidence angles.

Meanwhile, since the values at the camera module incidence angles of 0 degrees to +20 are inverted from the values at the camera module incidence angles of −20 degrees to 0 degrees according to the result of the comparative example shown in FIG. 5B, cancelling of the color dispersion in the disparity calculation is difficult.

As described above, according to the configuration of the present embodiment, it is possible to reduce an absolute value of the difference in the sensor incidence positions of the respective wavelengths for the light dispersion. Accordingly, highly-accurate ranging is possible in the present embodiment. Moreover, in the configuration of the present embodiment, as shown in FIG. 5A, it is possible to cause the sensor incidence position differences to occur in the same direction for the stereo camera incidence angles. This enables highly-accurate ranging. This means that the separation directions in the entrance of red and blue in the two images match each other, in the same direction as the direction in which the two images are arranged side by side on the sensor 12. These effects can be achieved by optimizing the refraction indices and prism angles of the prisms P10 and P20.

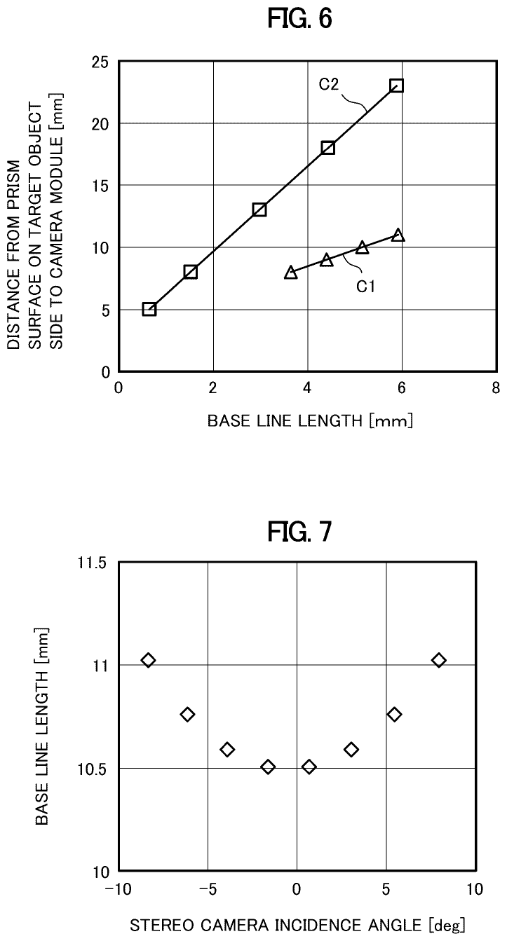

FIG. 6 is a graph showing relationships between a module distance and the base line length B (see FIGS. 1 and 2) in the configuration of the first embodiment (configuration of FIG. 1) and the configuration of the comparative example shown in FIG. 2.

The module distance is a distance from the prism surface on the target object side to the camera module 10.

In FIG. 6, reference sign C1 denotes a result in the configuration of the first embodiment (configuration of FIG. 1), and reference sign C2 denotes a result in the configuration of the comparative example (configuration of FIG. 2). Moreover, in FIG. 6, the horizontal axis represents the base line length B, and the vertical axis represents the module distance. According to FIG. 6, in the comparative example (reference sign C2), the module distance increases as the base line length B increases. In other words, it is found that the size of the stereo camera 1 increases as the base line length B increases. Meanwhile, in the configuration of the present embodiment (reference numeral C1), a change of the module distance with respect to a change of the base line length B is smaller than that in the comparative example (reference sign C2). In other words, since the present embodiment can suppress color dispersion, ranging accuracy can be improved.

In the configuration of the first embodiment (stereo camera 1 of FIG. 1), size reduction from the comparative example (stereo camera 1z of FIG. 2) can be achieved by increasing the refractive angle of the prism P10. Meanwhile, the prism angles on an entrance surface and an output surface of the prism P10 need to be increased to increase the refractive angle of the prism P10. Then, there is such a characteristic that, with this increase, the light rays L entering the prism P10 are shifted from the virtual viewpoint VP1 and the virtual viewpoint VP2 depending on the stereo camera incidence angle. This is explained with reference to FIG. 7.

FIG. 7 is a graph showing the base line length B with respect to the stereo camera incidence angle.

In this graph, the horizontal axis represents the stereo camera incidence angle, and the vertical axis represents the base line length B. Note that FIG. 7 shows a result obtained by the stereo camera 1 shown in FIG. 1, and the configurations of the prisms P10 and P20 and the camera module 10 are the same as those in FIG. 4A. According to FIG. 7, it is found that the base line length B in the case where the stereo camera incidence angle is 0 degrees is larger than the base line length B in the case where the stereo camera incidence angle is ±10 degrees. According to FIG. 7, the base line length seems to change depending on the incidence angle. To counter this, in the first embodiment, the distance to the target object is calculated with the base line length B changed depending on the stereo camera incidence angle and the position of the target object on the sensor 12. This enables more accurate ranging.

### Stereo Camera System Z

A processing method of a stereo camera system Z is explained with reference to FIGS. 8A and 8B.

FIG. 8A is a diagram showing a configuration of the stereo camera system Z, and FIG. 8B is a diagram showing a detailed configuration of a stereo disparity image generator 220.

The stereo camera system Z includes the stereo camera 1 and an image processing apparatus 2 that is a stereo image processing apparatus. The stereo camera system Z detects a three-dimensional object in the surrounding based on an image MO obtained by the camera module 10.

First, FIG. 8A is referred to.

As an example, the image processing apparatus 2 is configured to include an image processor 210, the stereo disparity image generator 220, and a stereo vision three-dimensional object detector 230.

The image processor 210 applies a predetermined image process to an image M1 and an image M2, and supplies processed images to the stereo disparity image generator 220. Moreover, the image processor 210 is configured to include an image separator 211, affine processors 212a and 212b, brightness correctors 213a and 213b, pixel interpolation units 214a and 214b, and brightness information generators 215a and 215b.

The stereo camera 1 detects the image M0 of the sensor 12 in the camera module 10 as shown in FIG. 3. Then, the image separator 211 separates the image M0 into two images of the image M1 (first detected image) and the image M2 (second detected image) depending on the virtual viewpoint VP1 and the virtual viewpoint VP2. For example, the image MI is the image detected in the sensor region 12A of FIG. 3, and the image M2 is the image detected in the sensor region 12B of FIG. 3. Specifically, the image M1 is an output signal of the first light receiving region (sensor region 12A), and the image M2 is an output signal of an output signal of the second light receiving region (sensor region 12B).

The affine processor 212a applies an affine process to the image M1. The affine process is, for example, a linear coordinate conversion process, but may be a process including non-linear calculation. As a result of performing the affine processing, the affine processor 212a outputs an image M3 (third image). Similarly, the affine processor 212b applies the affine process to the image M2, and outputs an image M4 (fourth image).

The brightness corrector 213a corrects the brightness of each pixel in the image M3. For example, the brightness of each pixel in the image M3 is corrected based on differences in gains of the respective pixels in the image M3 or the like. Similarly, the brightness corrector 213b corrects the brightness of each pixel in the image M4.

The pixel interpolation unit 214a performs a demosaicing process on the image M3. For example, conversion from a RAW image (Bayer array image) to a color image is performed. Similarly, the pixel interpolation unit 214b performs the demosaicing process on the image M4.

The brightness information generator 215a generates brightness information of the image M3. For example, the brightness information generator 215a converts information expressing the color image to brightness information for generating a disparity image. Similarly, the brightness information generator 215b generates the brightness information of the image M4. The generated images M3 and M4 are inputted into the stereo disparity image generator 220.

The stereo disparity image generator 220 generates the stereo disparity image by using the obtained images M3 and M4.

Details of the stereo disparity image generator 220 are shown in FIG. 8B.

As shown in FIG. 8B, the stereo disparity image generator 220 includes an exposure adjuster 221, a sensitivity adjuster 222, a geometric corrector 223, a matching unit 224, a noise remover 225, and a pixel shift amount calculator 226. The exposure adjuster 221 and the sensitivity adjuster 222 executes feedback control to the camera module 10 for an exposure amount, sensitivity, and the like of the camera module 10. Moreover, the geometric corrector 223 performs geometric correction of the two images M3 and M4, and the matching unit 224 performs a process of matching the left and right images (images M3 and M4). Furthermore, the noise remover 225 removes noise by using a smoothing process or the like, and the pixel shift amount calculator 226 calculates a pixel shift amount.

Description returns to explanation of FIG. 8A.

The stereo vision three-dimensional object detector 230 detects a three-dimensional object in a stereo vision region according to the stereo disparity image generated by the stereo disparity image generator 220. In this case, as shown in FIG. 7, the stereo vision three-dimensional object detector 230 changes the base line length B (see FIG. 1) depending on the stereo camera incidence angle. Then, the stereo vision three-dimensional object detector 230 can also measure the distance to the three-dimensional object based on the changed base line length B. Specifically, moreover, the stereo vision three-dimensional object detector 230 detects disparity by applying stereo matching to the detected three-dimensional object, and identifies the type of the three-dimensional object (pedestrian, bicycle, vehicle, building, or the like). The image processing apparatus 2 thereby detects disparity based on the output signals (images M1 and M2) of the sensor region 12A and the sensor region 12B.

### Hardware Configuration

FIG. 9 is a diagram showing a hardware configuration of the image processing apparatus 2.

The image processing apparatus 2 includes a memory 21 and a calculation device 22 formed of a CPU (central processing unit), a GPU (graphic processing unit), and the like. Moreover, the image processing apparatus 2 includes a storage device 23 such as an HD (hard disk) and an SSD (solid state drive). Furthermore, the image processing apparatus 2 includes an input device 24, an output device 25, and a communication device 26 that performs communication with the camera module 10.

A program is stored in the storage device 23, and is loaded onto to the memory 21. Then, the loaded program is executed by the calculation device 22. The units 210, 211 to 215b, 220, 221 to 226, and 230 shown in FIGS. 8A and 8B are thereby implemented.

The optical system and the processing method as described above can achieve the stereo camera 1 with only one camera module 10 and two prisms. The problem of small size and low cost can be thereby solved.

The distance detection method in the stereo camera 1 described in the first embodiment is not dependent on the projection method of the lens 11 in principle. For example, the projection method may be orthogonal projection (fsinθ) that is projection of a fish-eye lens, equidistant projection (fθ), equisolid projection (2fsin(θ/2)), or stereographic projection (2ftan(θ/2)). Note that f is the focal length of the lens 11, and θ is the camera module incidence angle.

Moreover, in the first embodiment, as shown in FIG. 1, the prism angle β10 of the surface S100 of the prism P10 and the prism angle β20 of the surface S200 of the prism P20 are 90 degrees. However, the prism angles β10 and β20 are not limited to this angle, and may be any prism angle.

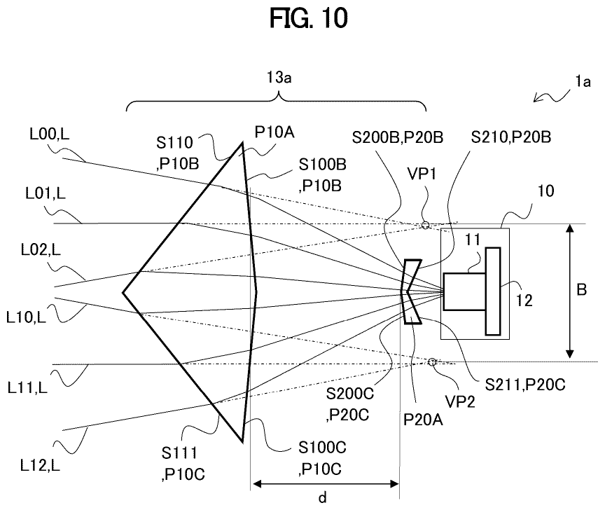

FIG. 10 is a diagram showing a modified example of the stereo camera 1 according to the first embodiment.

For example, a stereo camera la using prisms P10A and P20A as shown in FIG. 10 may be configured. Note that, in FIG. 10, a stereo adaptor 13a is formed of the prism P10A and the prism P20A. In this case, the prism P10A can be considered to include a prism region P10B and a prism region P10C. The prism region P10B is the first region, and includes the surface S110 and a surface S100B. Moreover, the prism region P10C is the second region, and includes the surface S111 and a surface 100C.

Moreover, the prism P20A can be similarly considered to include a prism region P20B and a prism region P20C. The prism region P20B is the third region, and includes a surface S200B and the surface S210. Furthermore, the prism region P20C is the fourth region, and includes a surface S200C and the surface S211.

Moreover, although the prisms P10 and P20 are explained to be line symmetric with respect to the optical axis N1 in the present embodiment, the prisms P10 and P20 are not limited to this, and may have different shapes on the upper and lower sides on the sheet surface. This can intentionally shift a detection direction of a viewpoint on one side. Furthermore, the prisms P10 and P20 of FIG. 1 may be shifted relative to the camera module 10 in the up-down direction on the sheet surface. Specifically, the prism P10 and the prism P20 may be arranged while being shifted in the up-down direction on the sheet surface, while being separated by the distance d with respect to the optical axis N1 (in the horizontal direction on the sheet surface). This allows the detection direction of the viewpoint on one side to be intentionally shifted.

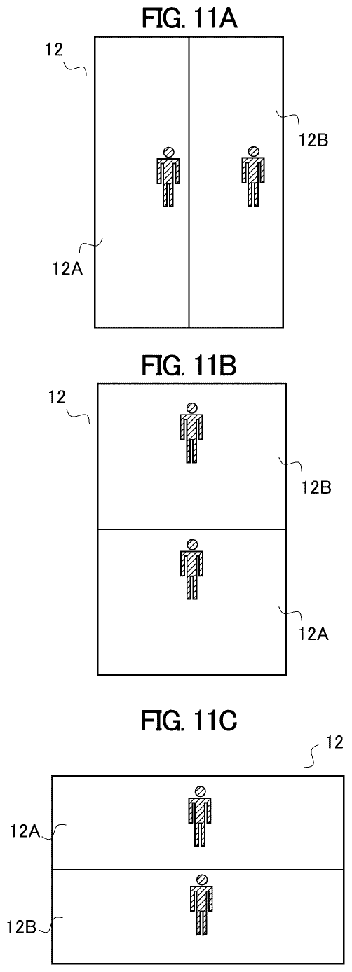

FIGS. 11A to 11B are diagrams showing arrangement examples of the sensor 12.

Although the oblong sensor 12 is arranged such that the horizontal direction is the longitudinal direction in the first embodiment, the sensor 12 may be arranged such that the vertical direction is the longitudinal direction as in FIG. 11A. Specifically, in the example shown in FIG. 11A, the longitudinal direction of the sensor 12 is a direction perpendicular to the direction in which the virtual viewpoint VP1 and the virtual viewpoint VP2 are arranged side by side. This case has such an advantage that the stereo camera incidence angle can be widened in a perpendicular direction (direction perpendicular to the ground). Moreover, for example, the prisms P10 and P20 and the lens 11 shown in FIG. 1 may be turned 90 degrees with respect to a depth axis of the stereo camera 1 including the sensor 12 shown in FIG. 11A. In this case, an image as shown in FIG. 11B is obtained. Furthermore, in the stereo camera 1 shown in FIG. 1 and including the sensor 12 arranged such that the horizontal direction is the longitudinal direction, it is also possible to turn only the prisms P10 and P20 90 degrees without turning the camera module 10. In this case, an image as shown in FIG. 11C is obtained.

In the cases of FIG. 3 and FIG. 11A, disparity in the horizontal direction (direction horizontal to the ground) is detected. Meanwhile, in the cases of FIGS. 11B and 11C, disparity in the perpendicular direction can be detected. Moreover, FIG. 11B has such an advantage that the stereo camera incidence angle in the perpendicular direction can be widened as in FIG. 11A. Meanwhile, FIG. 11C has such an advantage that the stereo camera incidence angle in the horizontal direction can be widened.

Effects of the prism P20 are described as supplementation with reference to FIGS. 12 to 15.

FIG. 12 is an optical path diagram in the case where the refractive index of the prism P10 in the comparative example is increased, and FIG. 13 is a diagram showing an example of an image focused on the sensor 12 by the configuration shown in FIG. 12.

A stereo camera 1z1 shown in FIG. 12 is an example in which the refractive index of the prism P10 used in Patent Literature 1 is increased in the configuration described in Patent Literature 1. Note that, although the orientation of the prism P10 is different from the prism P0 shown in FIG. 2, the results are the same.

Note that, in FIG. 12 and FIG. 13 to be described later, refraction in the optical path is shown in an exaggerated manner to give priority to ease of understanding. Moreover, in FIGS. 12 and 13, the same configurations as those in FIG. 1 are denoted by the same reference numerals, and explanation thereof is omitted.

In FIG. 12, a light ray L32 entering the prism P10 from a point near the optical axis N1 enters the surface S110, is then refracted, and reaches the sensor region 12B. Similarly, a light ray L31 entering the prism P10 from a point near the optical axis N1 enters the surface S111, is then refracted, and reaches the sensor region 12A.

Assume that the light ray L32 entering the surface S110 is not refracted in the prism P10. In this case, the light ray L32 travels along an optical path shown by the broken line, and reaches the virtual viewpoint VP1. Similarly, assume that the light ray L31 entering the surface S111 is not refracted in the prism P10. In this case, the light ray L31 travels along an optical path shown by the broken line, and reaches the virtual viewpoint VP2. It is desirable that the light ray L32 virtually detected at the virtual viewpoint VP1 is detected in the sensor region 12A. Similarly, it is desirable that the light ray L31 virtually detected at the virtual viewpoint VP2 is detected in the sensor region 12B.

However, in the configuration shown in FIG. 12, the light ray L32 that has entered the surface S110 reaches the sensor region 12B, and the light ray L31 that has entered the surface S111 reaches the sensor region 12A. A region 121 shown by dots in FIG. 13 is an image region formed by light that has entered the surface S110 and then reached the sensor region 12B and light that has entered the surface S111 and then reached the sensor region 12A as described above.

A picture of the image on the surface of the sensor 12 in the region 121 of FIG. 13 cannot be used for the object position detection. Accordingly, when the refractive index of the prism P10 is simply increased, a range that can be used for the object position detection in the picture of the image on the surface of the sensor 12 becomes smaller.

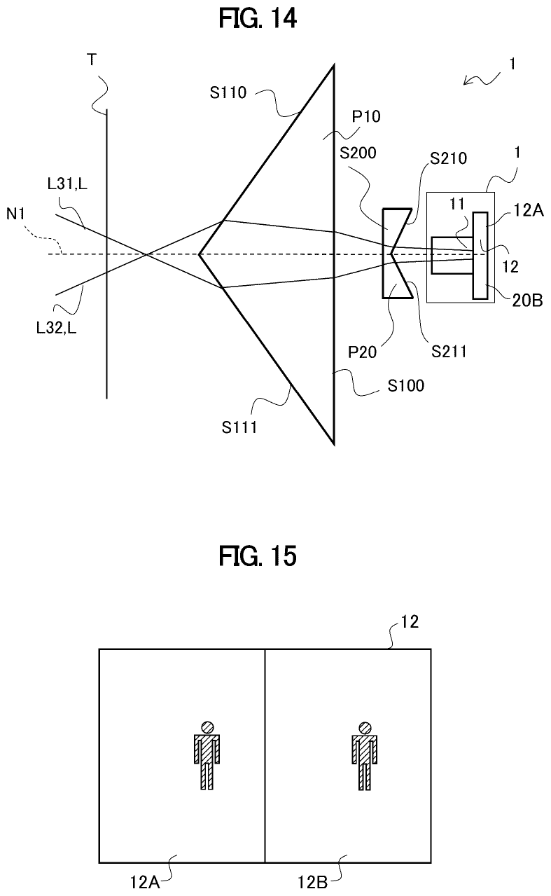

FIG. 14 is an optical path diagram of the stereo camera 1 according to the present embodiment shown in FIG. 1, and FIG. 15 is a diagram showing an example of an image focused on the sensor 12 by the configuration shown in FIG. 12.

In the stereo camera 1 shown in FIG. 14, the prism P20 that refracts light in the opposite direction to the prism P10 is provided in the stage subsequent to the prism P10. This causes the light ray L32 having entered the surface S110 to reach the sensor region 12A by being refracted by the prism P20. Similarly, the light ray L31 having entered the surface S111 reaches the sensor region 12B by being refracted by the prism P20. This can prevent the case where the region 121 in FIG. 13 is detected, as in the picture of the image on the surface of the sensor 12 shown in FIG. 15. Accordingly, in the configuration shown in FIG. 14, it is possible to increase the range of the image usable for the object position detection from that in the configuration shown in FIG. 12.

Moreover, in the present embodiment, the prism P10 and the prism P20 are separated from each other in series by the distance d in the direction of the optical axis N1, and this can suppress color dispersion and improve ranging accuracy.

### Second Embodiment

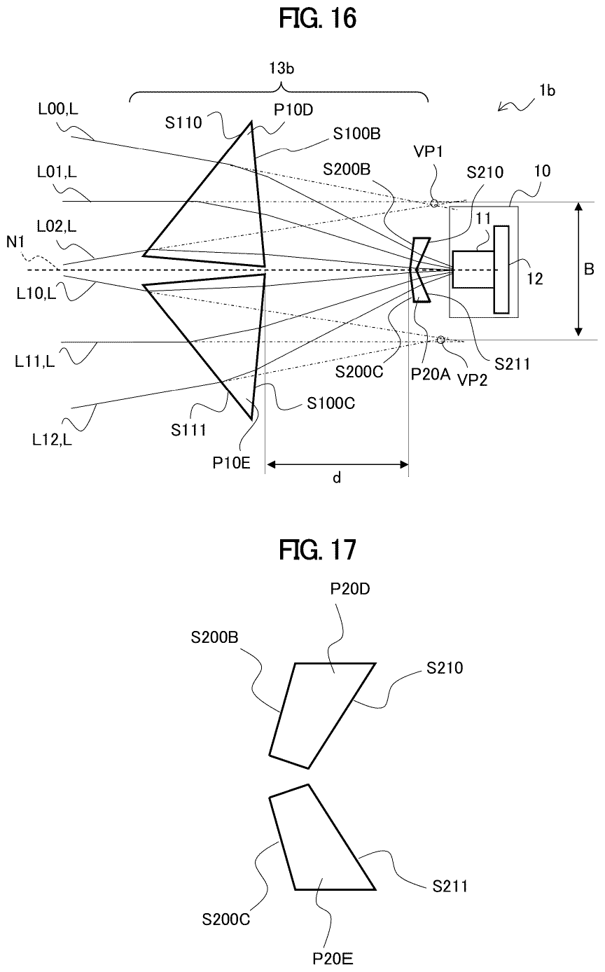

FIG. 16 is a configuration diagram of an optical system of a stereo camera 1b according to a second embodiment.

As shown in FIG. 16, effects similar to those of the first embodiment can be also obtained in the stereo camera 1b including prisms P10D and P10E that are obtained by spatially separating the prism P10A shown in FIG. 10 into two. Note that, in FIG. 16, a stereo adaptor 13b is formed of the prisms P10D, P10E, and P20A. The prism P10D shown in FIG. 16 includes the surface S110 and the surface S100B, and the prism P10E includes the surface S111 and the surface S100C. In FIG. 16, the prism P10D including the surface S110 and the surface S100B is the first region. Moreover, the prism P10E including the surface S111 and the surface 100C is the second region. Furthermore, the prism P10D and the prism P10E are spatially separated from each other.

This allows only the region where the light rays L are transmitted to be the prisms P10D and P10E, and an increase in the sizes of the prisms P10D and P10E can be thus prevented. Specifically, using the prisms P10D and P10E as shown in FIG. 16 enables omission of a prism portion corresponding to a portion of the sensor 12 where the light rays L not contributing to the detection in the image travel. The portion of the sensor 12 where the light rays L not contributing to the detection in the image on travel is the light rays L traveling near the optical axis N1. An increase in cost and an increase in stereo camera size can be thereby avoided. In other words, since this configuration enables omission of the unnecessary prism portion while preventing an increase in stereo camera size as in FIG. 1, the cost can be reduced.

FIG. 17 is a diagram showing another example of the prism P20 in the second embodiment.

As shown in FIG. 17, the prism P20A shown in FIG. 10 may be spatially separated into two. In this case, as shown in FIG. 17, prisms P20D and P20E are present. The prism P20D includes the surface S200B and the surface S210, and the prism P20E includes the surface S200C and the surface S211. In FIG. 17, the prism P20D including the surface S200B and the surface S210 is the third region, and the prism P20E including the surface S200C and the surface S211 is the fourth region. Moreover, the prism P20D and the prism P20E are spatially separated from each other. The prisms P20D and P20E shown in FIG. 17 can provide effects similar to those of the prisms P10D and P10E shown in FIG. 16.

Note that it is only necessary that one of the prism P10A and the prism P20A is spatially separated. Specifically, it is only necessary that one of the set of the prisms P10D and P10E in FIG. 16 and the set of the prisms P20D and P20E in FIG. 17 is arranged.

Moreover, the prisms P10D and P10E shown in FIG. 16 have configurations obtained by spatially separating the prism P10A shown in FIG. 10. However, the prisms P10D and P10E are not limited to this, and may have, for example, configurations obtained by spatially separating the prism P10 shown in FIG. 1. Moreover, the prisms P20D and P20E shown in FIG. 17 have configurations obtained by spatially separating the prism P20A shown in FIG. 10. However, the prisms P20D and P20E are not limited to this, and may have, for example, configurations obtained by spatially separating the prism P20 shown in FIG. 1.

Moreover, the glass martials of the prism P10 and the prism P20 are not limited to particular materials.

### Third Embodiment

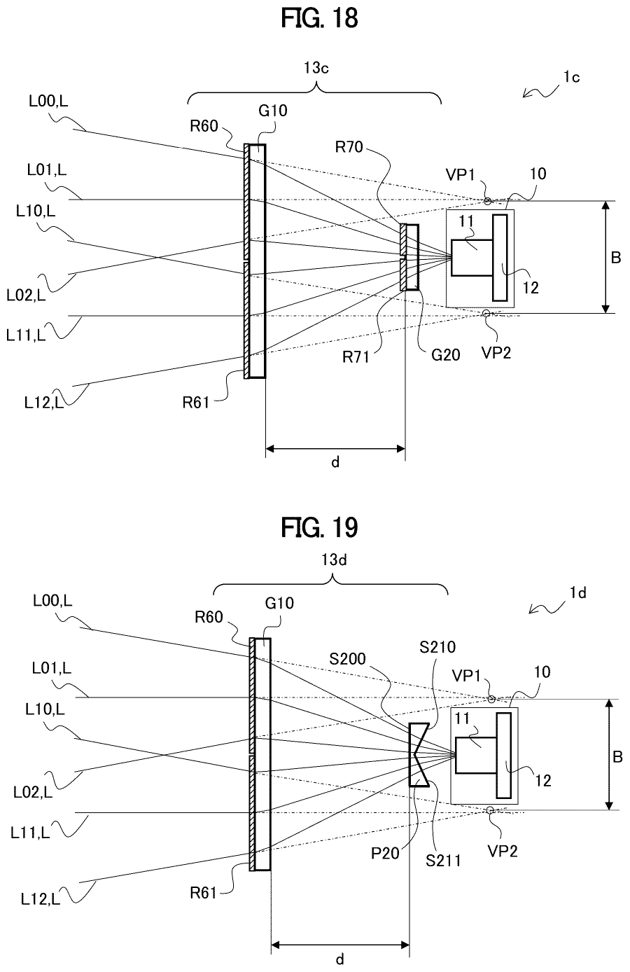

FIG. 18 is a configuration diagram of an optical system of a stereo camera lc according to a third embodiment of the present invention. A point where the stereo camera lc shown in FIG. 18 is different from the first embodiment is such a point that the prism P10 and the prism P20 shown in FIG. 1 are replaced by a divided diffraction grating G10 and a divided diffraction grating G20. Since other configurations are configurations similar to those in FIG. 1, these configurations are denoted by the same reference numerals as those in FIG. 1, and explanation thereof is omitted. Note that a stereo adaptor 13c is formed of the divided diffraction grating G10 and the divided diffraction grating G20. The light rays L entering the divided diffraction gratings G10 and G20 are transmitted through insides of the divided diffraction gratings G10 and G20.

The stereo camera 1c includes the divided diffraction grating G10 that has at least a region R60 and a region R61 and the divided diffraction grating G20 that is a diffraction grating having at least a region R70 and a region R71. Note that the region R60 corresponds to the first region, and the region R61 corresponds to the second region. Moreover, the region R70 corresponds to the third region, and the region R31 corresponds to the fourth region. Furthermore, the stereo camera 1c is characterized in that an interval between the two divided diffraction gratings G10 and G20 is such that the gratings G10 and G20 are separated from each other by the distance d in the front-rear direction. Note that, in the divided diffraction grating G10, a diffraction region where light is diffracted is divided into the region R60 and the region R61. Similarly, in the divided diffraction grating G20, a diffraction region where light is diffracted is divided into the region R70 and the region R71. Moreover, portions shown in white in the divided diffraction gratings G10 and G20 are made of a material that transmits light such as glass, crystal, or the like.

The light rays L00 to L02 propagating from the target object are diffracted in the region R60 of the divided diffraction grating G10 and in the region R70 of the divided diffraction grating G20. The light rays L00 to L02 then enter the camera module 10 formed of the lens 11 and the sensor 12. Similarly, the light rays L10 to L12 propagating from the target object are diffracted in the region R61 of the divided diffraction grating G10 and the region R71 of the divided diffraction grating G20. The light rays L10 to L12 then enter the camera module 10 formed of the lens 11 and the sensor 12. In this case, for example, like the light ray L00 and the light ray L10, light rays from the same target object are each diffracted in the region R60 and then in region R70 or diffracted in the region R61 and then in the region R71. Then, the diffracted light rays L enter the camera module 10 at different incidence angles.

The region 60 has similar optical characteristics to the surfaces S110 and S100a shown in FIG. 1, and the region R61 has similar optical characteristics to the surfaces S111 and S100b shown in FIG. 1. Similarly, the region 70 has similar optical characteristics to the surfaces S210 and S200a shown in FIG. 1, and the region 71 has similar optical characteristics to the surfaces S211 and S200b shown in FIG. 1.

Here, as in FIG. 1, lines extended from the light rays L traveling toward the divided diffraction grating G10 among the light rays L entering the camera module 10 are shown by dot-dash lines. Moreover, points where the dot-dash lines substantially intersect one another are defined as the virtual viewpoint VP1 and the virtual viewpoint VP2. The virtual viewpoint VP1 and the virtual viewpoint VP2 indicate effective positions of the camera module 10. Since the light rays L are diffracted on multiple surfaces, images detected in the sensor 12 are images similar to images detected at the virtual viewpoint VP1 and the virtual viewpoint VP2, respectively.

As described above, the characteristic of the second embodiment is that the interval between the two divided diffraction gratings G10 and G20 is such that the gratings G10 and G20 are separated from each other in the front-rear direction by the distance d. These two divided diffraction gratings G10 and G20 are characterized in that the diffraction angle of the divided diffraction grating G10 is larger than the diffraction angle of the divided diffraction grating G20. In such a configuration, the size reduction can be achieved even when the base line length B increased, due to a similar reason as that in the first embodiment.

FIG. 19 is a diagram showing another example of the stereo camera 1c according to the second embodiment.

Note that the divided diffraction gratings G10 and G20 used in FIG. 18 may be diffraction gratings such as holographic elements. Moreover, in the configuration of the present embodiment, the light rays L are bent in the center direction in the first element (prism P10, divided diffraction grating G10). Furthermore, the light rays L are bent toward the opposite side to the direction of the first element in the second element (prism P20, divided diffraction grating G20). Since the configuration is as described above, for example, as shown in FIG. 19, there may be configured a stereo camera 1d in which the first element is configured as the divided diffraction grating G10 and the second element is configured as the prism P20. Note that a stereo adaptor 13d is formed of the divided diffraction grating G10 and the prism P20. Moreover, surfaces of the prisms P10 and P20 shown in FIG. 1 may have a grating structure. This has an advantage of reducing the color dispersion. Moreover, as in the first embodiment, in the second embodiment, the arrangement direction of the sensor 12 is not limited to a particular direction. The direction may be such that the longitudinal direction of the sensor 12 is the direction in which the virtual viewpoint VP1 and the virtual viewpoint VP2 are arranged side by side. Alternatively, the longitudinal direction of the sensor 12 may be a direction perpendicular to the direction in which the virtual viewpoint VP1 and the virtual viewpoint VP2 are arranged side by side as shown in FIGS. 11A and 11B, or a direction oblique to the direction in which the virtual viewpoint VP1 and the virtual viewpoint VP2 are arranged side by side. Note that the light rays L falling on the sensor 12 need to perpendicularly fall on the imaging surface of the sensor 12.

Note that, in FIG. 19, only the prism P10 in the configuration of FIG. 1 may be replaced by the divided diffraction grating G10, or only the prism P20 in the configuration of FIG. 1 may be replaced by the divided diffraction grating G20. In other words, it is only necessary that at least one of the prism P10 and the prism P20 in the configuration of FIG. 1 is replaced by the divided diffraction grating G10 or G20.

### Modified Examples

The present invention is not limited to the above-mentioned embodiments, and includes various modified examples other than those described above. For example, the above-mentioned embodiments are explained in detail to explain the present invention in an easily-understandable manner, and the present invention is not necessarily limited to embodiments including all of the explained configuration. Moreover, some of the configurations in one embodiment may be replaced by configurations in another embodiment, or a configuration in one embodiment may be added to configurations of another embodiment. Furthermore, some of the configurations in each embodiment may be replaced or omitted, or other configurations may be added to the configurations in each embodiment.

The camera module 10 in the present embodiment may be any camera. For example, a camera of a mobile phone, a camera of a personal computer, or the like may be used as the camera module 10. In such a case, for example, the prisms P10 and P20 in FIG. 1 may be provided by being retrofitted to the camera of the mobile phone, the camera of the personal computer, or the like.

Moreover, some or all of the above-mentioned configurations and functions, the units 210, 211 to 215b, 220, 221 to 226, and 230, the storage device 23, and the like may be designed as, for example, an integrated circuit or designed in a similar manner to be implemented as hardware. Moreover, as shown in FIG. 9, the calculation device 22 such as a CPU may implement the above-mentioned configurations, functions, and the like as software by interpreting and executing a program that implements the functions. Information such as the program, a table, and a file for implementing the functions may be stored in the memory 21, a recording device such as an SSD, or a recording medium such as an IC (integrated circuit) card, a SD (secure digital) card, or a DVD (Digital Versatile Disc), instead of the HD.

Moreover, in each of the embodiments, control lines and information lines considered to be necessary for explanation are shown, and not all of control lines and information lines in a product are necessarily shown. Almost all of the configuration may be considered to be connected to one another in actual.

### REFERENCE SIGNS LIST

1, 1a to 1d, 1z, 1z1 stereo camera
2 image processing apparatus (stereo image processing apparatus)
10 camera module
11 lens (light condenser)
12 sensor (light receiver)
12A sensor region (first light receiving region)
12B sensor region (second light receiving region)
13, 13a to 13d stereo adaptor
220 stereo disparity image generator
230 stereo vision three-dimensional object detector
d distance (predetermined distance)
G10, G20 divided diffraction grating (diffraction element)
R60 region (first region)
R61 region (second region)
R70 region (third region)
R71 region (fourth region)
L, L00 to L02, L10 to L12, L31, L32 light ray
N1 optical axis
M0 image
M1 image (output signal of first light receiving region)
M2 image (output signal of second light receiving region)
P0 prism
P10 prism (first light ray angle conversion element)
P10A prism
P10B prism region (first region)
P10C prism region (second region)
P10D prism (first light ray angle conversion element, first region)
P10E prism (first light ray angle conversion element, second region)
P20 prism (second light ray angle conversion element)
P20A prism
P20B prism region (third region)
P20C prism region (fourth region)
P20D prism (second light ray angle conversion element, third region)
P20E prism (second light ray angle conversion element, fourth region)
S100 surface
S100a surface (first region)
S100b surface (second region)
S100B surface (first region)
S100C surface (second region)
S110 surface (first region)
S111 surface (second region)
S200 surface
S200a surface (third region)
S200b surface (fourth region)
S200B surface (second region)
S200C surface (fourth region)
S210 surface (third region)
S211 surface (fourth region)
T plane
Z stereo camera system
α10 prism angle (angle of tilt portion with smallest tilt with respect optical axis among tilt portions forming first prism)
α21 prism angle (angle of tilt portion with smallest tilt with respect optical axis among tilt portions forming second prism)

1. A stereo adaptor comprising a first light ray angle conversion element and a second light ray angle conversion element configured to change angles of light rays propagating from a target object, wherein
the light rays propagating from the target object propagate through insides of the first light ray angle conversion element and the second light ray angle conversion element, and
the first light ray angle conversion element and the second light ray angle conversion element are arranged at a predetermined distance from each other with respect to an optical axis.

2. The stereo adaptor according to claim 1, wherein
the first light ray angle conversion element includes at least a first region and a second region,
the second light ray angle conversion element includes at least a third region and a fourth region,
a direction in which an angle of the entering light ray is changed in the first region of the first light ray angle conversion element and a direction in which an angle of the entering light ray is changed in the second region of the first light ray angle conversion element are substantially opposite to each other, and
a direction in which an angle of the entering light ray is changed in the third region of the second light ray angle conversion element and a direction in which an angle of the entering light ray is changed in the fourth region of the second light ray angle conversion element are substantially opposite to each other.

3. The stereo adaptor according to claim 1, wherein
the first light ray angle conversion element includes at least a first region and a second region,
the second light ray angle conversion element includes at least a third region and a fourth region,
an angle of the light ray entering the first region of the first light ray angle conversion element and an angle of the light ray entering the third region of the second light ray angle conversion element are changed in opposite directions, and
an angle of the light ray entering the second region of the first light ray angle conversion element and an angle of the light ray entering the fourth region of the second light ray angle conversion element are changed in opposite directions.

4. The stereo adaptor according to claim 1, wherein
the first light ray angle conversion element is installed in a preceding stage that is an entrance side of the light rays, and the second light ray angle conversion element is installed in a subsequent stage, and
an angle of the entering light ray is changed in the first light ray angle conversion element such that the light ray travels toward a direction of the optical axis, and an angle of the entering light ray is changed in the second light ray angle conversion element such that the light ray travels in an opposite direction to the direction in the first light ray angle conversion element.

5. The stereo adaptor according to claim 1, wherein
the first light ray angle conversion element includes at least a first region and a second region, and
the first region and the second region of the first light ray angle conversion element are spatially separated from each other.

6. The stereo adaptor according to claim 1, wherein
the second light ray angle conversion element includes at least a third region and a fourth region, and
the third region and the fourth region of the second light ray angle conversion element are spatially separated from each other.

7. The stereo adaptor according to claim 1, wherein
the first light ray angle conversion element is formed of a first prism that is a prism, and
the second light ray angle conversion element is formed of a second prism that is a prism different from the first prism.

8. The stereo adaptor according to claim 7, wherein a refractive index of the first prism is larger than a refractive index of the second prism.

9. The stereo adaptor according to claim 8, wherein an angle of a tilted portion with the smallest tilt with respect to the optical axis among tilted portions forming the first prism is smaller than an angle of a tilted portion with the smallest tilt with respect to the optical axis among tilted portions forming the second prism.

10. The stereo adaptor according to claim 1, wherein at least one of the first light ray angle conversion element and the second light ray angle conversion element is a diffraction element.

11. The stereo adaptor according to claim 1, wherein the first light ray angle conversion element and the second light ray angle conversion element are arranged in series with respect to the optical axis.

12. A stereo camera comprising:
a first light ray angle conversion element and a second light ray angle conversion element configured to change angles of light rays propagating from a target object;
a light condenser configured to focus an image formed by light transmitted through the first light ray angle conversion element and the second light ray angle conversion element; and
a light receiver configured to detect the focused image, wherein
the light rays propagating from the target object propagate through insides of the first light ray angle conversion element and the second light ray angle conversion element, and
the first light ray angle conversion element and the second light ray angle conversion element are arranged at a predetermined distance from each other with respect to an optical axis.

13. The stereo camera according to claim 12, wherein
the first light ray angle conversion element includes at least a first region and a second region,
the first light ray angle conversion element includes at least a third region and a fourth region,
the light receiver includes a first light receiving region and a second light receiving region,
the light ray transmitted through the first region of the first light ray angle conversion element and the third region of the second light ray angle conversion element is made to fall on the first light receiving region by the light condenser, and
the light ray transmitted through the second region of the first light ray angle conversion element and the fourth region of the second light ray angle conversion element is made to fall on the second light receiving region by the light condenser.

14. The stereo camera according to claim 13, wherein a separation direction in entrance of red and blue in the first light receiving region matches the separation direction in the second light receiving region, in the same direction as a direction in which the first light receiving region and the second light receiving region are arranged side by side.

15. A stereo camera system comprising:
a first light ray angle conversion element and a second light ray angle conversion element configured to change angles of light rays propagating from a target object;
a light condenser configured to focus an image formed by the light rays transmitted through the first light ray angle conversion element and the second light ray angle conversion element;
a light receiver configured to detect the focused image; and
a stereo image processing apparatus, wherein
the first light ray angle conversion element includes at least a first region and a second region,
the first light ray angle conversion element includes at least a third region and a fourth region,
the light rays propagating from the target object propagate through insides of the first light ray angle conversion element and the second light ray angle conversion element,
the first light ray angle conversion element and the second light ray angle conversion element are arranged at a predetermined distance from each other with respect to an optical axis,
the light receiver includes a first light receiving region and a second light receiving region,
the light ray transmitted through the first region of the first light ray angle conversion element and the third region of the second light ray angle conversion element is made to fall on the first light receiving region by the light condenser,
the light ray transmitted through the second region of the first light ray angle conversion element and the fourth region of the second light ray angle conversion element is made to fall on the second light receiving region by the light condenser, and
the stereo image processing apparatus detects disparity based on output signals of the first light receiving region and the second light receiving region.

16. The stereo camera system according to claim 15, wherein
a distance is estimated based on the disparity, and
in estimation of the disparity, a base line length is changed depending on a stereo camera incidence angle that is an angle of the light ray entering the first light ray angle conversion element and that is an incidence angle of the entering light ray with respect to a plane perpendicular to an optical axis.
